(19) United States
(12) Patent Application Publication
(10) Pub. No.: US 2007/0132672 A1
(43) Pub. Date: Jun. 14, 2007

(54) Organic el drive circuit and organic el display device using the same

(76) Inventors: Jun Maede, Kyoto (JP); Hiroshi Yaguma, Kyoto (JP); Shinichi Abe, Kyoto (JP); Akio Fujikawa, Kyoto (JP)

Correspondence Address: Mattingly Stanger Malur & Brundidge, 1800 Diagonal Road, Suite 370, Alexandria, VA, 22314, US

(21) Appl. No.: 10/593,864

(22) PCT Filed: Mar. 22, 2005
(86) PCT No.: PCT/JP05/05122

§ 371 Date: Sep. 22, 2006

(30) Foreign Application Priority Data
Mar. 24, 2004 (JP) 2004 -087012

(51) Int. Cl. G09G 3/30

(52) U.S. Cl. 345/76

(57) ABSTRACT

[Problem]To provide an organic EL drive circuit and an organic EL display device, capable of restricting an area taken by gamma correction circuits provided correspondingly to terminal pins. [Means for Solving the Problem]An organic EL drive circuit includes switch circuits for connecting the terminal pins to a predetermined potential line according to a reset pulse, a correction data generator circuit for generating correction data for correcting a light emitting period of the organic EL element according to display data for gamma correction of luminance of the organic EL element and a reset pulse generator circuit for generating the reset pulse having pulse width corresponding to the gamma correction according to the first timing control signal and the correction data.

### TECHNICAL FIELD

This invention relates to an organic EL drive circuit and an organic EL display device using the same organic EL drive circuit and, in particular, the present invention relates to an organic EL drive circuit of an organic EL display device of an electronic device such as a portable telephone set or a PHS, which is capable of restricting an area occupied by gamma (γ) correction circuits provided corresponding to terminal pins of the organic EL display device.

### BACKGROUND ART

An organic EL display panel of an organic EL display device mounted on a portable telephone set, a PHS, a DVD player or a PDA (portable terminal device) having 396 (132×3) terminal pins of column line and 162 terminal pins of row line device has been proposed and the number of terminal pins of the column line and the number of terminal pins of row line tend to be further increased.

Similarly to a CRT, luminance of each of organic EL elements (refer to OEL elements, hereinafter) of an organic EL display panel is not linearly changed to display data but and the luminance becomes a curved line corresponding to element characteristics due to materials of three primary colors R, G and B. Therefore, when environment of the organic EL display device is changed, image quality is changed. The change of image quality becomes conspicuous when resolution of the organic EL display panel becomes higher. For this reason, gamma correction becomes necessary.

Incidentally, Patent Reference 1 of the applicant of this application discloses the gamma correction, which is performed by using series-connected resistors as a load resistance of an output circuit (output stage current source) for outputting drive currents to terminal pins of column line and by selecting each resistor of the series-connected resistor circuit.

Patent Reference 1: JP2003-288051A

### DISCLOSURE OF THE INVENTION

### Problem to be Solved by the Invention

In Patent Reference 1 (JP2003-288051A), D/A converters and output stage current sources are provided correspondingly to column pins on a column side and the output stage current sources are driven by currents obtained by D/A conversion of display data by the D/A converters to output drive current for driving OEL elements to the terminal pins.

In general, when gamma correction is to be performed, it is considered to correct display data set in the D/A converters correspondingly to gamma correction by software processing in driver, etc. In such case, gamma correction is impossible by D/A converters of 4 to 6 bits. Therefore, in JP2003-288051A, the gamma correction circuits are provided correspondingly to the output stage current sources.

However, when the gamma correction circuit is constructed with the series resistor circuit composed by series-connecting the load resistors of the output stage current sources, the number of resistors and the number of switches for selecting the load resistance become very large. Since the gamma correction circuit has a contrary effect in view of reduction of power consumption, another gamma correction circuit capable of restricting an area occupied by the current drive circuit is necessary.

An object of the present invention is to provide an organic EL drive circuit capable of restricting an area occupied by gamma correction circuits provided correspondingly to terminal pins and an organic EL display device using the organic EL drive circuit.

### Means for Solving the Problem

An organic EL drive circuit according to the present invention in which drive currents for driving OEL elements or a current, on which the drive currents are generated, are generated by converting digital display data into analog signal, sending the drive currents to the OEL elements through terminal pins of the OEL elements in a display period according to a first timing control signal for sectioning the display period corresponding to a scan period for one horizontal line from a reset period corresponding to a retrace period of the one horizontal line and resetting the terminal voltages of the OEL elements in the reset period, comprises switch circuits for connecting the terminal pins to a predetermined potential line according to a reset pulse, a correction data generating circuit for generating correction data for correcting a light emitting period of the OEL element according to display data for gamma correction of luminance of the OEL element and a reset pulse generator circuit for generating the reset pulse having pulse width corresponding to the gamma correction according to the first timing control signal and the correction data.

### Advantage of the Invention

Incidentally, the constant voltage resetting for precharging the terminal of the OEL element to a predetermined constant voltage is performed. Therefore, a waveform of the drive current supplied to the OEL elements corresponding to column pins of the OEL element drive circuit becomes a peak current waveform (solid line), which starts from the predetermined constant voltage as shown in FIG. 6(g). Incidentally, a dotted line in FIG. 6(g) shows a voltage waveform.

The constant voltage resetting is performed during the reset period RT corresponding to the retrace period of horizontal scan and the display period D in this state corresponds to the horizontal scan period for one horizontal line. Thus, the sectioning between the display period D and the reset period RT is performed by the timing control pulse TP (FIG. 6(j)) having a period (corresponding to horizontal scan frequency) corresponding to (display period D+reset period RT). Incidentally, FIG. 6 shows waveforms of drive currents flowing to the respective terminal pins and the timing signal for generating the drive currents.

FIG. 6(a) is a sync clock CLK on which timings of various control signals are determined, FIG. 6(b) is a count start pulse CSTP of a pixel counter and a count value of the pixel counter is shown in FIG. 6(c). FIG. 6(d) shows a display start pulse DSTP and FIG. 6(e) is a reset pulse RSR for R (red).

The reset pulse RSR is generated by the timing control pulse TP for generating a reference timing of sectioning between the display period and the reset period.

The timing control pulse TP is the same as the reset control signal in driving the passive matrix type organic EL display panel when the timing control pulse is a pulse for resetting or precharging (constant voltage resetting) the OEL element through column pin in the retrace period of the column side driving.

Since the sectioning between the display period and the reset period is the reference timing, the reset pulse RSR shown in FIG. 6(e) becomes the same as the timing control pulse TP or the reset control pulse (reset control signal). This is the same for G (green) and B (blue) generated on the basis of the timing control pulse TP, except that the reset periods of G and B may be different from that of R.

According to this invention, a current display period D is controlled by generating reset pulses corresponding to respective column pins and gamma-correcting a start timing of a next reset period. By correcting a light emitting period of the OEL element in this manner, a total luminance of the OEL element in the display period is gamma-corrected.

The gamma correction circuit of this invention is provided as a reset period control circuit. As a result, the gamma correction becomes possible by timing control and so it is possible to restrict the area taken by the gamma correction circuits.

Further, by using a data conversion ROM as the correction data generator circuit, it is enough to record the selection of gamma correction value and, since it is unnecessary to provide the data conversion ROMs correspondingly to the column pins, it becomes possible to restrict the area taken by the gamma correction circuits, correspondingly.

### BEST MODE FOR CARRYING OUT THE INVENTION

FIG. 1 is a block circuit diagram showing an organic EL display panel using an organic EL drive circuit according to an embodiment of the present invention, FIG. 2 is a gamma correction reset pulse generator circuit provided in an output stage current source, FIG. 3 shows another gamma correction reset pulse generator circuit, FIG. 4 shows the reset pulse generation timing of the gamma correction reset pulse generator circuit shown in FIG. 3, FIG. 5 shows the gamma correction data set in the data conversion circuit (ROM) and FIG. 6 shows drive current waveforms for driving the column pins and timing signals by which these waveforms are generated.

In FIG. 1, a reference numeral 10 depicts a column driver IC (refer to “column driver”, hereinafter) as an organic EL drive circuit of an organic EL display panel. The column driver 10 includes a reference current generator circuit 1, an R-reference current generator circuit 2R provided for R (red), a G-reference current generator circuit 2G provided for G (green) and a B-reference current generator circuit 2B provided for B (blue).

The reference current generator circuits 2R, 2G and 2B have current mirror circuits, which are provided as input stages of the reference current generator circuits. In response to a reference current Iref from the reference current generator circuit 1, the reference current generator circuits 2R, 2G and 2B generate reference currents Ir, Ig and Ib corresponding to the respective colors. Input side transistors of current mirror circuits (reference current distribution circuits) 3R, 3G and 3B (3G and 3B are not shown) are driven by the reference currents Ir, Ig and Ib, so that the reference currents Ir, Ig and Ib are distributed to output terminals (output terminals XR1 to XRn for R).

Incidentally, since the current mirror circuits 3G and 3B connected to the G-reference current generator circuit 2G and the B-reference current generator circuit 2B are similar to the current mirror circuit 3R connected to the R-reference current generator circuit 3R, the current mirror circuits 3G and 3B are not shown.

In each of the reference current generator circuits 2R, 2G and 2B, a D/A converter circuit (D/A) 2a of about 4 bits is provided to regulate the reference currents Ir, Ig and Ib corresponding to display colors for the white balance regulation. The white balance regulation is performed by D/A conversion of data D set in the respective registers 2b by the D/A converter circuits 2a.

In the following description, a current drive system for the R-reference current generator circuit 2R and the current mirror circuit 3 for R will be described. Description of current drive systems for G and B are omitted.

The R-reference current generator circuit 2R is driven by the reference current Iref from the reference current generator circuit 1 to generate the reference current Ir. The reference current Ir is supplied to an input side transistor Tra of the current mirror circuit 3 for R. Therefore, respective output side transistors Trb to Trn generate the reference currents Ir, which are distributed to the respective output terminals XR1 to XRn.

The current mirror circuit 3 includes the input side P channel MOSFET Tra and the output side P channel MOSFETs Trb to Trn having sources connected to a power source line +VDD (=+3V).

Drains of the output side P channel MOSFETs Trb to Trn are connected to D/A converters 4R, respectively, and the output currents Ir from these drains are reference drive currents of the D/A converters 4R.

Each D/A converter 4R is constructed with a current mirror circuit and the output current Ir is supplied to an input side transistor of the current mirror circuit. A display data DAT is supplied to the output side transistor of the current mirror circuit from an MPU 11 through a register 6 and a line 8b. The D/A converter 4R amplifies the reference drive current Ir correspondingly to the display data to generate drive current corresponding to display luminance of the OEL element every time to thereby drive an output stage current source 5R with the amplified drive current.

Each of the output stage current sources 5R includes an output stage current mirror circuit 50, a gamma correction reset pulse generator circuit 51 and a switch circuit 52

The current mirror circuit 50 is constructed with a P channel input side transistor QP1 and a P channel output side transistor QP2 and sources of the transistors QP1 and QP2 are connected to a power source line +Vcc (voltage of the voltage line +Vcc>voltage of the voltage line +VDD). A drain of the transistor QP1 is diode-connected to a gate thereof and to an output terminal of the D/A converters 4R, so that it is driven by the D/A converter 4R. A drain of the transistor QP2 is connected to one of the output terminals XR1 to XRn, which corresponds to the transistor QP2.

Thus, the output stage current sources 5R output drive currents i to anodes of respective OEL elements 9 through the column side output terminals XR1 to XRn.

The switch circuits 52 are reset switches provided correspondingly to the respective output terminals XR1 to XRn for R and are constructed with P channel MOSFETs QP3, respectively. A source of the transistor QP3 of the output stage current source 5R is connected to one of the output terminals XR1 to XRn, which corresponds thereto. A drain of the transistor QP3 of the output stage current source 5R is grounded through a Zener diode DZR. The transistor QP3 is turned ON by a gate drive signal supplied from the gamma correction reset pulse generator circuit 51 provided in its output stage current source 5R to a gate thereof to set the output terminal connected thereto to the constant voltage VzR to thereby reset the terminal voltage of the OEL element 9 connected to the output terminal.

The gamma correction reset pulse generator circuit 51 receives a correction data TDi from a data conversion circuit (ROM) 7 and the timing control pulse TP from the control circuit 12 through the line 8a. Further, the gamma correction reset pulse generator circuit 51 receives the clock CLK and the display stat pulse DSTP from the control circuit 12. The gamma correction reset pulse generator circuit 51 generates the gate drive signal with a predetermined timing corresponding to a value of the correction data TDi and supplies the gate drive signal to the switch circuit 52 (transistor QP3) to turn the switch circuit 52 ON. Therefore, the reset period RT corresponding to the value of the display data DAT is set in the output terminal. As a result, the length of the light emission period D corresponding to the reset period RT is corrected with respect to the gamma correction value, so that luminance of the OEL element is gamma-corrected.

When the switch circuit 52 is turned ON in the reset period RT, an anode of the OEL element 9 is set to the constant voltage VZR of the Zener diode DZR. Therefore, light emission of the OEL element 9 is stopped and the anode is pre-charged to a predetermined voltage. A cathode of the OEL element 9, which emits light, is grounded by a scanning in a vertical direction (row line).

Incidentally, as shown in FIG. 1, the output terminals XR1 to XRn correspond to the column pins of the organic EL display panel, respectively, and the output terminal and the corresponding column pin connected thereto are integral each other. Therefore, in this description, the output terminal and the corresponding column pin are not distinguished.

The data conversion circuit (ROM) 7 is constructed with a ROM and a multiplexer and generates the correction data TDi for gamma-correcting light emission period of the OEL element 9 by converting the display data. The data conversion circuit 7 sequentially receives display data DAT corresponding to the output terminals through a line 8c, sequentially selects the gamma correction reset pulse generator circuits 51 by the multiplexer according to a control signal S from the control circuit 12 and distributes the converted correction data TDi to the gamma correction reset pulse generator circuits 51 through a line 8d correspondingly to the output terminals.

The control signal S is generated with the count timing of the pixel counter, which is housed in the control circuit 12 and starts the counting according to a count start pulse CSTP shown in FIG. 6(b).

The data conversion of the data conversion circuit 7 is performed by using a display data value Di inputted with a certain timing as an address value of the data conversion circuit 7, accesses an address corresponding to the display data value Di and outputting a correction data TDi stored in the address Di.

The correction data TDi outputted determines the start timing of the reset period RT as well as the end timing of the display period D.

FIG. 5 is a graph showing data value to be data converted for the gamma correction.

Abscissa depicts display data value and ordinate depicts an average drive current value [μA] generated from the output terminal.

A dotted line A is an average output current value of the output stage current source when the display period D (=light emission period) is set to a predetermined constant value DT and γ=1.0. In this case, it is assumed that the average output current corresponds to the total luminance of the OEL element 9 in the light emission period D.

A solid line B is an average output current value corresponding to γ=2.0. By providing an OFF period of the average output current corresponding to a drive current difference DI between the dotted line A and the solid line B in the display period DT, it is possible to correct to γ=2.0. This is because the light emission luminance and the display period are substantially in corresponding relation.

That is, the display period D without gamma correction is depicted by DT, the gamma correction period is Tγ and the display period (=light emission period) with gamma correction is T. In the equations below, the current value corresponding to a certain data value Di in the line A is depicted by a, the current value when the display data Di in the line B is depicted by b, td is a clock period, Dγi is a period represented by clock count number in the gamma correction period Tγ, TDr is count value from a rising of the timing control pulse TP (see FIG. 6(e)) to an end of the display period DT without gamma correction, which corresponds to, for example, the reset start period of the reset pulse RSR shown in FIG. 6(e).

The period TDi representing the display period by the clock count number with gamma correction can be obtained by the following equations:

The display period T with gamma correction is represented by
T=DT×b/a (1)

The gamma correction period Tγ is represented by
Tγ=DT−DT×b/a=DT(1−b/a) (2)

The clock number Dγi of the gamma correction period Tγ is represented by
Dγi=Tγ/td (i=0 to 63) (3)

The clock number TDi of the display period T with gamma correction is represented by
TDi=TDr−Dγi (4)

Incidentally, the equation (4) shows the period (display period with gamma correction) from the display start time to a time when the output current of the output stage current source 5R is OFFed with respect to the display period DT without gamma correction by the clock number TDi. That is, the equation (4) provides a display period, which is shorter than the period from the display start time of the display period DT without gamma correction to the reset start time, that is, the display period D from the display start time to the reset start time shown in FIG. 6(e) and is used as a reference with gamma correction.

By storing the corrected data TDi in an address of the display data Di of the ROM, the corrected data TDi corresponding to the display data Di is obtained and the gamma correction is performed for the display period when γ=2.0. Incidentally, i=0 to 63 is for the case when the display data is of 6 bits.

In respective regions of the ROM of the data conversion circuit 7, a number of data are stored correspondingly to gamma correction such that the gamma correction value can be selected by using header addresses of the respective regions. Thus, it is possible to perform various gamma correction by selecting the header address. Further, it is enough to provide one ROM of the data conversion circuit 7 for the R output terminals XR1 to XRn.

As shown in FIG. 2, the gamma correction reset pulse generator circuit 51 is constructed with a preset counter 53, a flip-flop 54 and an inverter 55. In the preset counter 53, correction data TDi is loaded from the data conversion circuit 7 with the timing of the control signal S.

The preset counter 53 starts the count-down the correction data TDi with the falling timing of the timing control pulse TP (FIG. 6(e)) according to the clock CLK from the control circuit 12 and, when the count becomes “0”, the preset counter 53 generates an output.

A rising of the output of the preset counter 53 is inputted to the flip-flop 54 as a trigger signal. Incidentally, a data input terminal D of the flip-flop 54 is pulled up. Therefore, data “1” is set in the flip-flop 54 according to the rising edge of the output of the preset counter 53 and a Q output of the flip-flop 54 is sent to a gate of the transistor QP3 through the inverter 55 as the reset pulse RSR. Incidentally, in this case, it may be possible to utilize a Q bar output of the flip-flop 54 without using the inverter 55.

The display start pulse DSTP generated by a timing signal generator circuit 12a of the control circuit 12 is supplied to the reset terminal R of the flip-flop 54, so that the flip-flop 54 is reset with the timing of a rising edge of the display start pulse to terminate the reset pulse RSR.

Incidentally, when the count value of the preset counter 53 is “0”, the falling edge of the timing control pulse TP is inputted to the flip-flop 54 as a trigger signal.

As a result, when there is no gamma correction, the gamma correction reset pulse generator circuit 51 generates the reset pulse RSR, which rises according to the correction data TDi (=TDr) preset in the preset counter 53 as shown in FIG. 6(e), 6(h) or 6(i). When Dγi=0, the correction data TDi becomes (=TDr−0) and the reset pulse RSR shown in FIG. 6(e) is generated. When Dγi=1, the correction data TDi becomes (=TDr −1) and the reset pulse RSR, which is shifted back by 1 clock and shown in FIG. 6(h), is generated. Further, when Dγi=2, the correction data TDi becomes (=TDr−2) and the reset pulse RSR shown in FIG. 6(i) is generated. These can be said generally that, when Dγi=n (n is an integer), the correction data TDi becomes (=TDr−n).

As shown by the equations (3) and (4), the reset pulses RSR shown in FIGS. 6(e), 6(h) and 6(i) rise with the gamma corrected timing corresponding to the value of the display data DAT and fall upon the display start pulses DSTP. These reset pulses are generated periodically with a period (period of the timing control signal=horizontal scan frequency) corresponding to a sum of the display period D and the reset period RT, which is predetermined.

FIG. 3 is a block circuit diagram of another gamma correction reset pulse generator circuit and FIG. 4 shows the generation timing of the reset pulse.

In the embodiment shown in FIG. 1, the control for elongating the reset period on the start side correspondingly to the gamma correction on the basis of the reset period determined by the timing control signal for sectioning between the display period corresponding to the scan period for one horizontal line and the reset period corresponding to the retrace period of the one horizontal line. In this embodiment, by setting the display period sectioned by the timing control signal as a shortest display period in the case where the gamma correction is performed, the timing control is performed such that a front portion of this reset period is removed according to the gamma correction by using the reset period as a reference.

A gamma correction reset pulse generator circuit 51a is constructed with an n-stage shift register 56, a selector 57, a 2-input AND gate 58, a 3-bit register 59 and inverters 60 and 61. The n-stage shift register 56 is responsive to the timing control pulse TP from a timing signal generator circuit 12a and a clock signal CLK supplied through the inverter 60 to generate output waveforms shown in FIG. 4(a).

Incidentally, in FIG. 4(a), the stage number n of the shift register 56 is 4 and flip-flops Q1 to Q4 of the respective stages are used for simplicity of description. Practically, the number of stages of the shift register 56 may be about 32 for the longest period of gamma correction. Output signals of the flip-flops Q1 to Q4 are generated correspondingly to falling of the clock CLK inputted to the respective stages of the shift register 56. The flip-flops Q2 to Q4 are delayed from the initial stage flip-flop Ql by 1 to several clocks. Incidentally, the rising timing of the flip-flop Q1 is delayed by a time period from the rising of the timing control pulse TP shown in FIG. 6(j) to a falling of the clock CLK synchronized with the timing control pulse.

The selector 57 is responsive to the output signals of the first to last stages of the shift register 56 and an input signal (the timing control pulse TP from the timing signal generator circuit 12a) to the initial stage of the shift register 56 and selects one of the input signals. The selection of the input signal of the selector 57 is performed according to TDi set in the register 59. The selected input signal is inputted to one of the 2 input terminals of the AND gate 58. The timing control signal TP shown in FIG. 6(j) is inputted to the other input of the AND gate as an input of the shift register 56.

The falling timing of the timing control pulse TP in this case is fixed to the display start position and the rising timing thereof is set to a position preceding the shortest display period D when gamma correction is performed by at least a half clock. Usually, the timing control pulse TP shown in FIG. 6(j) is generated on the basis of the timing control pulse TP shown in FIG. 6(e).

The timing control pulse TP shown in FIG. 6(j) is set to the shortest display period D in the case the gamma correction is performed or less and used as the signal for sectioning between the display period D and the reset period RT. Therefore, the reset period RT is set to the longest period when the gamma correction is performed or more.

Incidentally, the data value TDi set in the register 59 is represented by
TDi=TDir−Dp (5)
where TDir is the clock number TDi calculated by the equation (4) and Dp is the number of clocks counted until the timing control pulse TP shown in FIG. 6(j) rises.

Therefore, the correction data stored in the data conversion circuit 7 becomes TDi calculated by not the equation (4) but the equation (5).

As a result, the reset pulse RSR delayed from the initial stage by m clocks (m is an integer) is generated at the output of the AND gate 58 corresponding to the data value set in the register 56. This reset pulse RSR has a rising (leading edge) corresponding to the rising (leading edge) of the timing control pulse TP or the rising (leading edge) of selected one of the outputs of the flip-flops Q1 to Q4 and a falling (trailing edge) corresponding to the falling (trailing edge) of the timing control pulse TP, as shown in FIGS. 6(e), 6(h) and 6(i). This reset pulse RSR is supplied to the gate of the transistor QP3 through an inverter 61. Incidentally, a NAND gate may be used insead of the AND gate 58 and the inverter 61.

Assuming that the shift register 56 has the 4-stage construction and TDi is 3-bit, the 3-bit correction data TDi set in the register 56 is in a range from 0 to 4 corresponding to the number of output stages of the shift register 56. Therefore, assuming that the 3-bit correction data TDi set in the register 56 of the reset pulse generator circuit 3R is “011”, that is, 3, the output of the flip-flop Q3 is selected as shown in FIG. 4(b) and the output of the AND gate 58 is delayed from the output of the flip-flop Q1 by 2 clocks as shown in FIG. 4(b) and delayed from the timing control pulse TP by 3 clocks.

As a result, the reset pulse RSR shown in FIG. 6(e) is generated from the reset pulse generator circuit 3R. In this case, TDi=TDr=“011” and this is the display period DT without correction.

In the case of the reset pulse RSR shown in FIG. 6(i), the 3-bit correction data set in the register 56 of the reset pulse generator circuit 3G is TDi=“010” and delayed from the timing control pulse TP by 2 clocks.

In the case of the reset pulse RSR shown in FIG. 6(h), the 3-bit correction data set in the register 56 of the reset pulse generator circuit 3B is TDi=“001” and delayed from the timing control pulse TP by 2 clocks.

The output of the AND gate 58 is sent to the gate of the transistor QP3 constructing the switch circuit 52 through the inverter 61 and “L” level signal is outputted to the gate of the transistor QP3 through the inverter 58 during the output of the AND gate 58 is “H”, so that the transistor QP3 is turned ON.

In the above described embodiment, the reset pulse RSR for R is generated correspondingly to the gamma correction. The reset pulses for G and B are similarly generated correspondingly to gamma correction.

Further, in the described embodiment, the start timing of the reset pulse RSR is set by counting clocks with using the falling (leading edge) of the timing control pulse TP shown in FIG. 6(e) as the reference. However, since the period of the timing control pulse TP is constant, it is of course possible to count clocks by using the rising (trailing edge) thereof as a reference.

### BRIEF DESCRIPTION OF THE DRAWINGS

FIG. 1 is a block circuit diagram of an embodiment of an organic EL display panel to which an organic EL drive circuit according to an embodiment of an organic EL display device is applied.

FIG. 2 is a block circuit diagram of a gamma correction reset pulse generator circuit provided in an output stage current source.

FIG. 3 is a block circuit diagram of another gamma correction reset pulse generator circuit.

FIG. 4 show reset pulse generating timing of the gamma correction reset pulse generator circuit in FIG. 3.

FIG. 5 is a graph showing gamma correction data set in a data conversion circuit (ROM).

FIG. 6 shows current waveforms for driving column pins and timing signals for generating the timing signals.

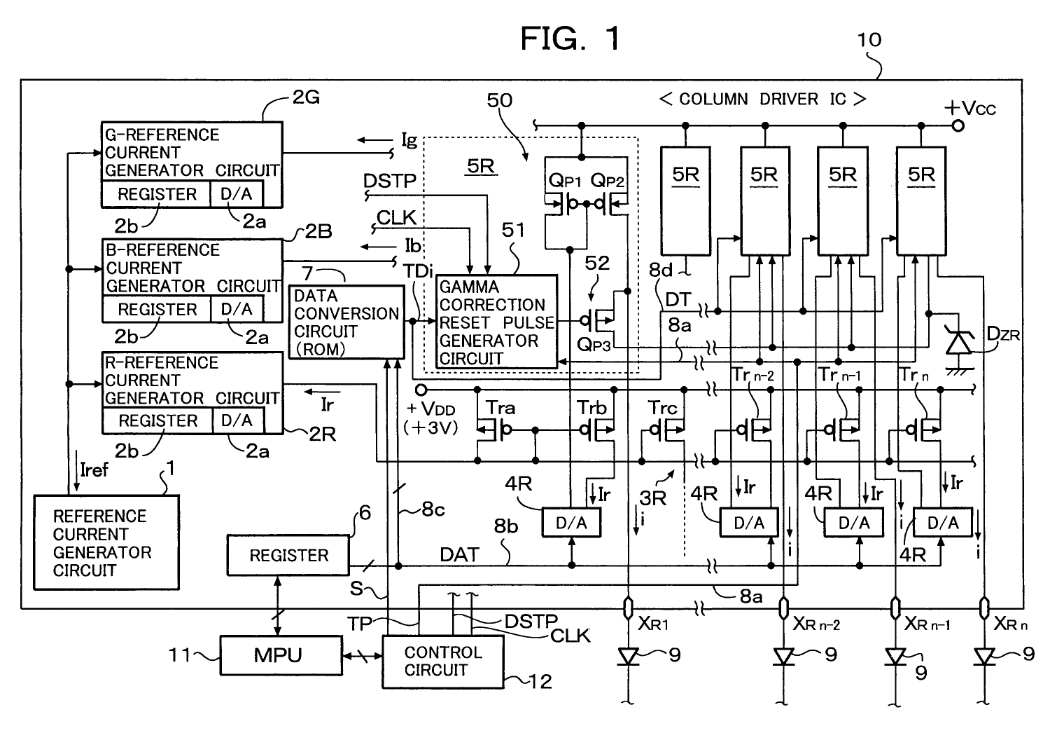

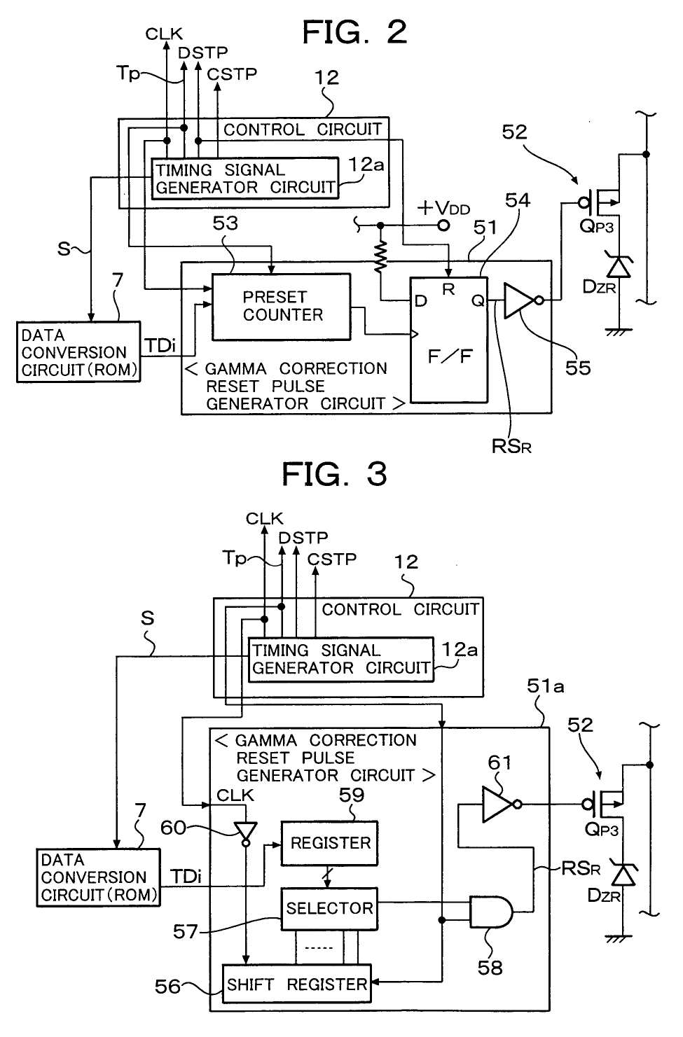

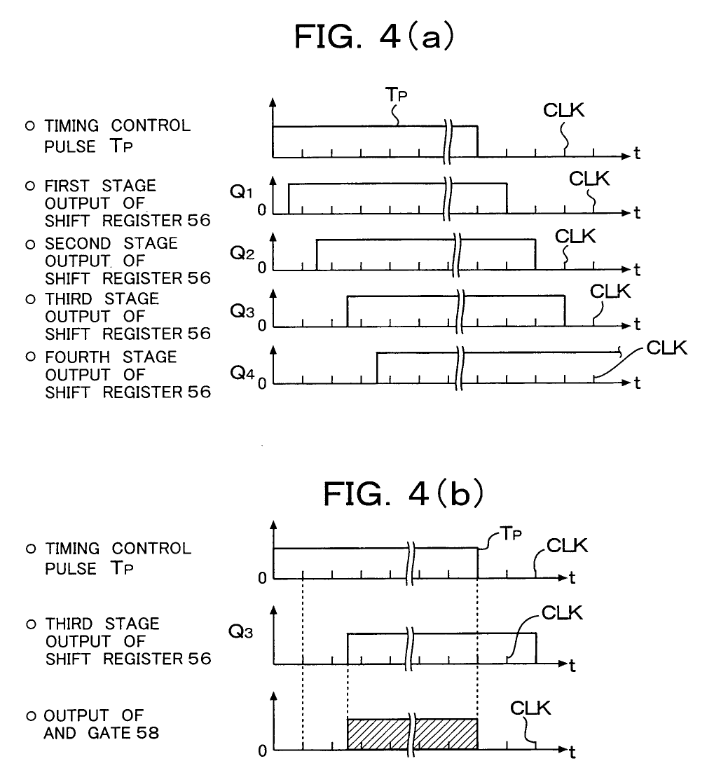

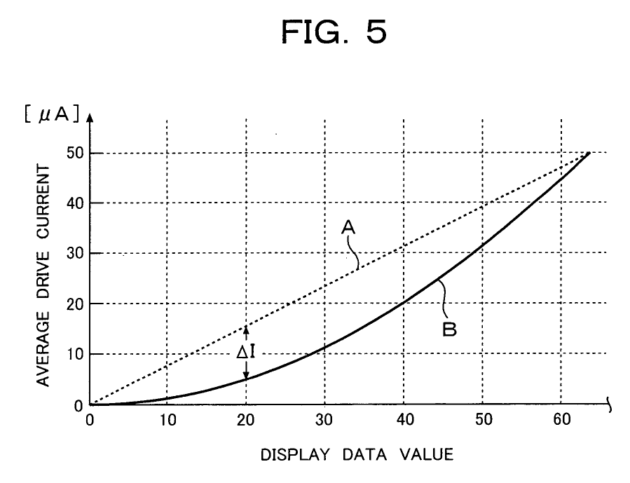

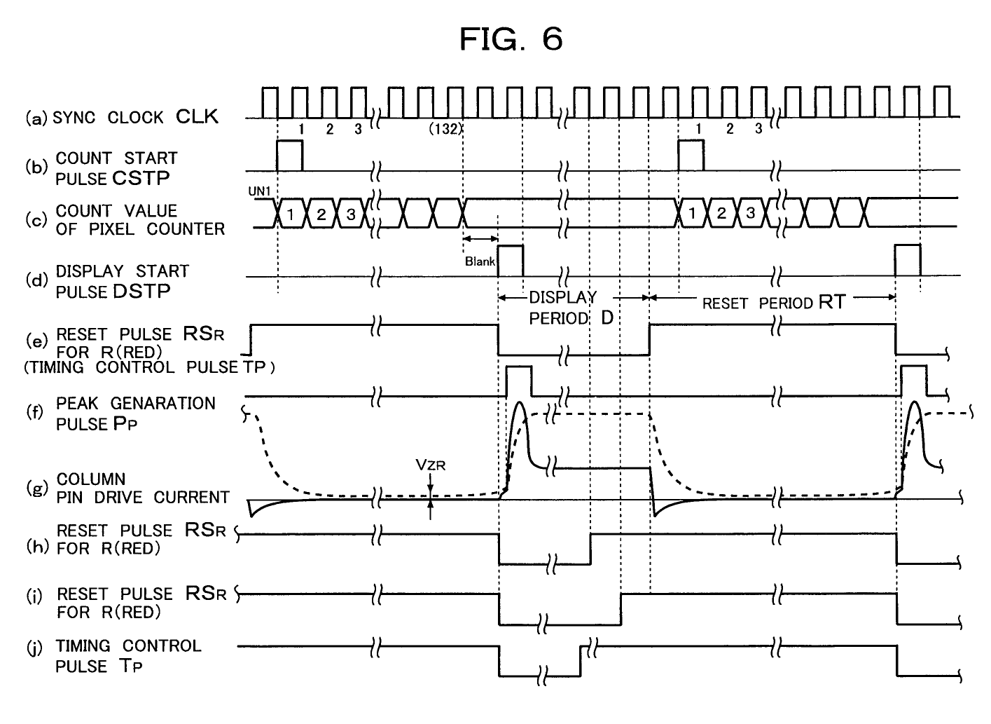

### DESCRIPTION OF REFERENCE NUMBERALS AND SIGNS

1G, IR, 1B . . . reference current generator circuits for R, G and B
2G,2R, 2B . . . reference current distribution circuits for R, G and B
3, 3G, 3R, 3B . . . D/A converter
4, 4G, 4R, 4B . . . peak current generator circuit
5, 5R, 5G, 5B . . . output stage current source
6 . . . register
7 . . . data conversion circuit (ROM)
9 . . . OEL element
12 . . . control circuit
50 . . . output stage current mirror circuit
51a . . . gamma correction reset pulse generator circuit
52 . . . switch circuit
53 . . . preset counter
54 . . . flip-flop
55, 60, 61 . . . inverter
56 . . . shift register
57 . . . selector
58 . . . 2-iput AND gate
59 . . . 3-bit register Tra to Trn, QP1 to QP3 . . . transistor

1. An organic EL drive circuit in which drive currents for driving organic EL elements or a current, on which the drive currents are generated, are generated by converting digital display data into analog signal, sending the drive currents to the organic EL elements through terminal pins of the organic EL elements in a display period according to a first timing control signal for sectioning the display period corresponding to a scan period for one horizontal line from a reset period corresponding to a retrace period of the one horizontal line and resetting the terminal voltages of the OEL elements in the reset period, comprising:
switch circuits for connecting the terminal pins to a predetermined potential line according to a reset pulse;
a correction data generator circuit for generating correction data for correcting a light emitting period of the organic EL element according to display data for gamma correction of luminance of the organic EL element; and
a reset pulse generator circuit for generating the reset pulse having pulse width corresponding to the gamma correction according to the first timing control signal and the correction data.

2. The organic EL drive circuit as claimed in claim 1, wherein the correction data generator circuit is a data conversion circuit for converting the display data into the correction data.

3. The organic EL drive circuit as claimed in claim 2, wherein the reset pulse is generated as a signal delayed from a timing reference, which is a leading edge or a trailing edge of the first timing control signal, by a predetermined amount corresponding to the correction data.

4. The organic EL drive circuit as claimed in claim 2, further comprising a counter for counting the number of clocks corresponding to the correction data, wherein the predetermined delay is generated correspondingly to an output of the counter.

5. The organic EL drive circuit as claimed in claim 4, wherein the organic EL panel is of the passive matrix type, the terminal pins are a plurality of column pins and the first timing control signal is a reset control signal.

6. The organic EL drive circuit as claimed in claim 5, wherein the switch circuit is constructed with a transistor, a plurality of the switch circuits are provided correspondingly to the column pins, one ends of the switch circuits are connected to the column pins and the other ends of the switch circuits are connected to a potential line set to a predetermined constant voltage.

7. The organic EL drive circuit as claimed in claim 6, wherein the predetermined potential line is provided as a connection line to a constant voltage circuit having current mirror current sources for generating the drive currents correspondingly to the column pins, the transistors are MOS transistors, ones of the sources and drains of the MOS transistors are connected to outputs of the current sources and the others are connected to the constant voltage circuit.

8. The organic EL drive circuit as claimed in claim 2, wherein the switch circuit, the correction data generator circuit and the reset pulse generator circuit are provided for each of three primary colors R, G and B and the data conversion circuit is constructed with a ROM.

9. The organic EL drive circuit as claimed in claim 2, wherein the first timing control signal sets the display period to the shortest display period with gamma correction or shorter to sections between the display period and the reset period.

10. The organic EL drive circuit as claimed in claim 9, wherein the reset pulse generator circuit includes a delay circuit for generating a plurality of second timing control signals sequentially delayed by predetermined time in response to the first timing control signal and a selection circuit for selecting one of the plurality of the second timing control signals in response to the plurality of the second timing control signals, the first timing control signal and the correction data to generate the reset pulse having a leading edge corresponding to the leading edge of the selected second timing control signal and a trailing edge corresponding to the first timing control signal.

11. The organic EL drive circuit as claimed in claim 6, further comprising current sources for generating the drive currents and D/A converter circuits provided correspondingly to the terminal pins, wherein the D/A converter circuit converts the display data into an analog signal correspondingly to a reference current or a current generated on the basis of the reference current and drives the current source according to the analog signal.

12. An organic EL display device comprising an organic EL drive circuit claimed in and the organic EL panel.

13. The organic EL display device as claimed in claim 12, wherein the organic EL drive circuit is provided as an IC.
